(19) United States
(12) Patent Application Publication
(10) Pub. No.: US 2022/0309464 A1
(43) Pub. Date: Sep. 29, 2022

(54) METHOD AND SYSTEM FOR REAL TIME COLLABORATION, EDITING, MANIPULATING, SECURING AND ACCESSING MULTI-MEDIA CONTENT

(71) Applicant: SHOWRUNNER INDUSTRIES INC., Los Angeles, CA (US)

(72) Inventor: Jeffrey Alan Schechter, Los Angeles, CA (US)

(21) Appl. No.: 17/633,584

(22) PCT Filed: Aug. 12, 2020
(86) PCT No.: PCT/US2020/045986

§ 371 Date: Feb. 8, 2022

Related U.S. Application Data
(60) Provisional application No. 62/885,744, filed on Aug. 12, 2019.

(51) Int. Cl. G06Q 10/10

(52) U.S. Cl. CPC G06Q 10/101; G06Q 10/103

(57) ABSTRACT

The present invention discloses an electronic platform for users, such as show writers, to create show content for TV series, film and other formats. Unique, interrelated graphical user interfaces (GUIs) enable users with input devices and displays to enter, manipulate and review show content on virtual index cards displayed on electronic “white boards” enabling both in-person and remote collaboration of teams of writers, securely and efficiently.

### RELATED APPLICATIONS

This application claims the benefit of U.S. Provisional Application No. 62/885,744 filed on Aug. 12, 2019.

### TECHNICAL FIELD

The present invention relates generally to the field of content creation collaboration, and, in particular, to systems, methods and graphical user interfaces for multi-media collaboration system that enables content creators, such as TV and film producers and writers, to create, edit, manipulate, secure, and remotely access the creative content used in TV and film script development.

### BACKGROUND

For decades, “show writers” in the conventional “writers' room”—a setting, often a single room, for the writers of films and television shows—have used a standard set of tools to help them develop themes for, and write, structure, and revise television broadcast, cable, streaming or other online format series, feature films, and other entertainment content in other formats, such as radio and podcasts (all such content generally hereinafter called “shows”). These tools include physical whiteboards and corkboards, often mounted on the walls of the writers' room, and index cards and/or Post-It® notes (generically, “cards”) onto which units of content are written. The cards are handwritten, often revised several times, before being pinned, taped or pasted onto the usually large format corkboards or whiteboards. While offering show writers good visual access at different levels of detail and flexibility in terms of card/note placement and rearrangement, this long-standard way and process for writing shows is inefficient and less than ideal, especially for current times. Besides the tediousness of handwriting (and often tossing in the garbage) dozens of paper index cards per episode of a show, the conventional method is prone to losing or misplacing cards, inaccessible outside of the writers' room, the content is unsecure (i.e., it is visible to anyone who enters the writers' room, such as visitors and unauthorized viewers), and it is unduly time-consuming and clumsy due to the physical writing and rewriting of cards, as well as the physical placement and movement of cards and handwritten notes on the boards as story beats change and get reordered. Moreover, the physical board-card system does not permit the association of cards on one board with related cards on one or more other boards in the writers' room. In short, the writing and re-writing of index cards, as well as their manipulation is tedious, time-consuming, inefficient and poorly secured. And, of course, this conventional process does not allow for real time collaboration of writers that are not in the writers' room—i.e., physically remote from each other.

In more recent years, numerous software tools are used by writers and producers to help them organize and manage the show creation process. These include project management software, word processors, note and text editors for electronically writing down their ideas for shows, spreadsheets and even some software that tries to mimic corkboards. These software tools are also ineffective because they comprise a jury-rigged hodgepodge of unlinked applications that do not easily give multiple users access to the same information. No software exists that enables the creation and free manipulation of text specific to story development in a way that writers want and need today.

Accordingly, what is needed is an effective electronic system that eliminates the problems of conventional physical and electronic systems and methods. Such a system would eliminate the need for physical index cards in favor of an electronic content collaboration system, giving content creators a much higher degree of control, flexibility and security over the content being created than previously possible.

### SUMMARY

The present invention meets these needs by disclosing an electronic show writing platform that solves the aforementioned problems and more. The platform includes a unique set of interrelated graphical user interfaces (GUIs) for users to enter and manipulate electronic, or virtual, index cards onto electronic boards in a way that is user friendly, intuitive, flexible and secure for show writers and show producers.

The present invention discloses a unique combination of features and display formatting heretofore not seen that substantially advances the ability of the industry to create and manipulate content from any computer and remotely collaborate with teams of writers securely and efficiently.

It is to be understood that the invention is not limited in its application to the details of construction and the arrangement of components described hereinafter and illustrated in the drawings and photographs. Those skilled in the art will recognize that various modifications can be made without departing from the scope of the invention.

### BRIEF DESCRIPTION OF THE DRAWINGS

Further advantages of the present invention may become apparent to those skilled in the art with the benefit of the following detailed description of the example embodiments and upon reference to the accompanying drawings in which:

FIG. 1 is an overview diagram of an example of the client processing structure and a server processing structure in accordance with one non-limiting embodiment of the present invention;

FIG. 2 is a diagram describing an exemplary workflow embodiment for signing up for the software service of the present invention, the project creation, and display of the project;

FIGS. 2a-2c are representative detailed screens shown in the flow diagram of FIG. 2.

FIGS. 3a-3d are representations of example design of each of the four boards/screens the software will generate;

FIG. 4 is an expanded view of an exemplary season board showing how cards may be created and manipulated, as well as common navigation elements that may be found on users' screens;

FIG. 5 is an expanded-view an exemplary individual card accordingly to the present invention, showing some preferable navigation and modification controls;

FIGS. 6a and 6b are representative examples of how hyperlink searching may appear in the software:

FIG. 7 is a flow diagram showing one exemplary method for using one embodiment of the present invention; and

FIG. 8 is a block diagram of exemplary hardware components that may implement one or more embodiments of the present invention.

### DETAILED DESCRIPTION OF THE PREFERRED EMBODIMENTS

Referring now to the drawings, like reference numerals designate identical or corresponding features throughout the several views.

The inventor has implemented one preferred embodiment of the present invention—a TV series content creation, manipulation and remote collaboration platform, called WritersRoom Pro™ (“WRP”)—available at https://www.writersroompro.com/, Exemplary features of an early version of WRP are shown in the following figures.

Disclosed herein is a computer-implemented method for developing content for a show by one or more users. The method may comprise electronically entering editable story arc content on one or more Story Arc Cards (SACs) for display on a first screen comprising a Season Board matrix that linearly presents the one or more SACs for each one or more selected episodes of a season of the show, with the SACs for each episode displayed with an associated Episode Number Card (ENC) identifying the episode number for the SACs of that episode; and electronically entering editable episode act content on one or more Episode Act Cards (EACs) for display on a second screen comprising an Episode Board matrix that linearly displays the entered EACs for acts of the selected episode of a selected season. Each ENC displayed on the Season Board matrix may include a link to its corresponding Episode Board matrix, such that activating the link causes the corresponding Episode Board matrix to be displayed.

The method of may further include entering editable character content on Character Development Cards (CDCs) for one or more characters in the show across episodes of a given season, the CDCs for display on a third screen comprising a Character Board matrix that linearly displays the CDCs of each character across episodes of the selected season of the show.

The SACs and associated ENCs may be selectably displayed on the Season Board matrix in a linearly vertical or horizontal orientation. Moreover, the EACs may be selectably displayed on the Episode Board matrix in a linearly vertical or horizontal orientation. The method of the present invention may be implemented such that multiple users may enter and edit content on SACs and EACs remotely from each other. The method may operate in a Software as a Service (SaaS) environment. Multiple users may enter and edit SACs and EACs simultaneously.

The present invention also discloses one or a set of graphical user interfaces (GUIs) for one or more users using one or more input devices and displays, in order to enter, view and navigate content for a show. These GUIs include a Season Board matrix for displaying on a first screen user-selectable and editable Story Arc Cards (SACs) for one or more selected episodes of a season of the show, the matrix including an Episode Number Card (ENC) associated with the SACs for each episode, the ENCs identifying the episode number of the selected season; and an Episode Board matrix for displaying on a second screen user-selectable and editable Episode Act Cards (EACs) for each act of a selected episode.

Moreover, each Episode Number Card displayed on the Season Board matrix may include a link to its corresponding Episode Board matrix, such that activating said link causes the corresponding Episode Board matrix to be displayed.

In embodiments, the invention may further include a Character Board matrix for display on a third screen user-selectable and editable Character Development Cards (CDCs) for one or more characters in the show across episodes of a given season. In embodiments, the invention may include a Scrap Board for display on a fourth screen user-selectable and editable content.

The present invention also discloses an apparatus that includes a show development module, which may include hardware and software or an application stored remotely in the cloud or locally. The module may be configured to provide access to one or more users to input, revise and review content for a show on screens of one or more electronic displays. The apparatus may include a processor and a memory that is not a transitory propagating signal, the memory operably coupled with the processor and encoding computer readable instructions, including processor executable program instructions, the computer readable instructions accessible to the processor, wherein the processor executable program instructions, when executed by the processor, cause the processor to perform operations. The operation may comprise displaying a user editable Season Board matrix on a first screen, comprising one or more user-entered Story Arc Cards (SACs) for one or more selected episodes of a selected season of the show; and, an Episode Number Card (ENC) associated with each one or more SACs of an episode; displaying a user editable Episode Board matrix on a second screen, comprising Episode Act Cards (EACs) for each act of a selected episode; and navigating from the user editable Season Board matrix to the user editable Episode Board matrix of the selected episode by selecting at least a portion of the Episode Number Card corresponding to the selected episode.

In embodiments, the show development module of the apparatus may be accessible via a network to remote input devices of credentialed users for simultaneous viewing, inputting and editing by the users of the Season Board and Episode Board matrices.

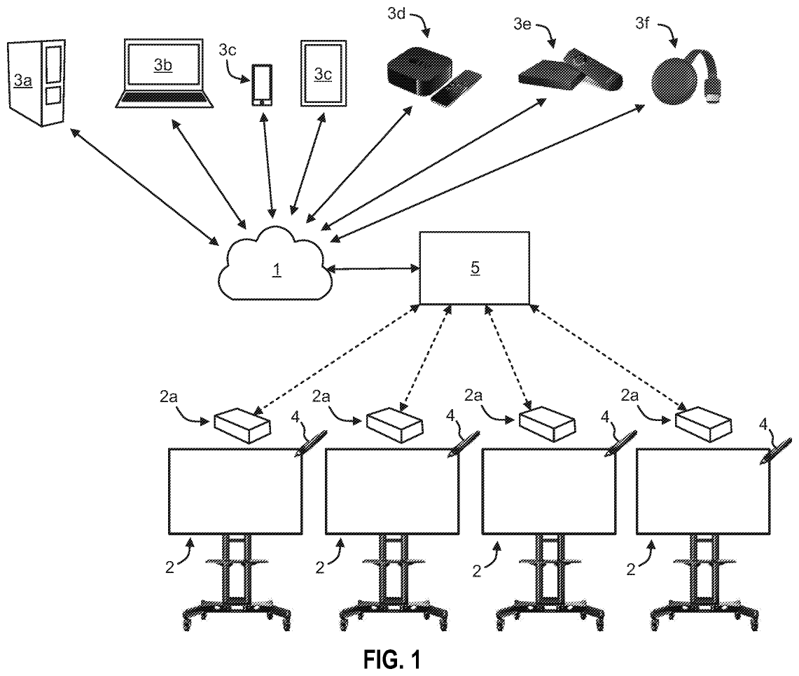

Turning to the figures, FIG. 1 shows an overview diagram of one exemplary, non-limiting, environment of the present invention as implemented in a client/server, cloud based environment, showing a client processing structure and a server processing structure with display monitors that may be used in a writers' room. In particular, the system may include some or all of the following components: a cloud-based server or servers 1; single or multiple touchscreen display monitors 2, each connected to an external single board computer (SBC) 2a which connects to the Internet through wired and/or wireless network interfaces such as WIFI, Bluetooth, Ethernet, etc. Remote user-connected devices may include a desktop computer (3a), laptop computer (3b), handheld device (3c), or internet television device such as Apple TV (3d), Amazon Fire TV (3e), or Google ChromeCast (3f). An optional stylus or other pointing device 4 may be used for entering/manipulating text and on-screen objects on any displays of any of the devices.

In one specific, non-limiting implementation, namely, in a conventional setting of a writers' room where writers collaborate in person, four (4) large-format single or multiple displays 2 may be placed around a writers' room as digital replacements of physical whiteboards or corkboards conventionally found in the writers' room. Preferably, each display accesses a web browser built into (stored in) the SBC (single board computer) 2a that is used to control the system through a wired or wireless connection to access to the software 5 of the present invention (detailed below) through a dedicated cloud-based server 1. Alternatively, the software may be run on a local sever with a display operating in a client mode. Either way, display 2 then accesses and displays one of several screens generated by the software 5 and selected by the user. If any of the displays are touchscreen-enabled, the user can physically enter and manipulate the data on the screens with either their finger or a stylus (4). For the writers' room embodiment, the display monitors 2 may be any size desired by the user, but preferably being no smaller than 55″ diagonally. Indeed, as the prices for flat screen displays have plummeted in recent years, larger sizes ranging from 65″ to even 100″ display can populate the writers' room.

In other current and increasingly relevant embodiments of the present invention, large format displays 2 in the writers' room may not be required or even used at all. Use of the present invention may occur in completely remote individual or team collaboration scenarios, where a physical writers' room may not be required or used at all, such as in an environment where all show writers working on a V series are working from their homes. In such case, each show writer will access the software of the present invention, most commonly via a secure, password protected, web-based portal, using one or more of connected devices 3 as their input and display devices. In such a remote collaboration embodiment, users can log into the software on a their desktop computer (3a), laptop computer (3b), a handheld device (3c), or an internet television device such as Apple TV (3d), Amazon Fire TV (3e), or Google ChromeCast (3f) and enter data into the software through a keyboard connected to that device. Moreover, when content is changed on any screen, that change is mirrored on the same screen for all users who are concurrently or later logged into the same project.

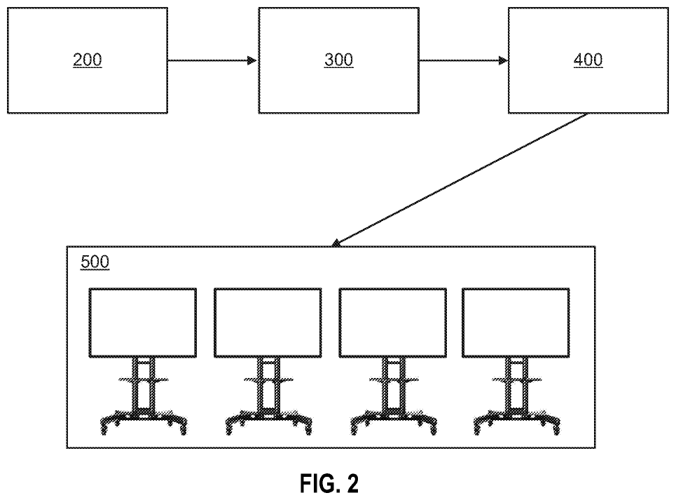

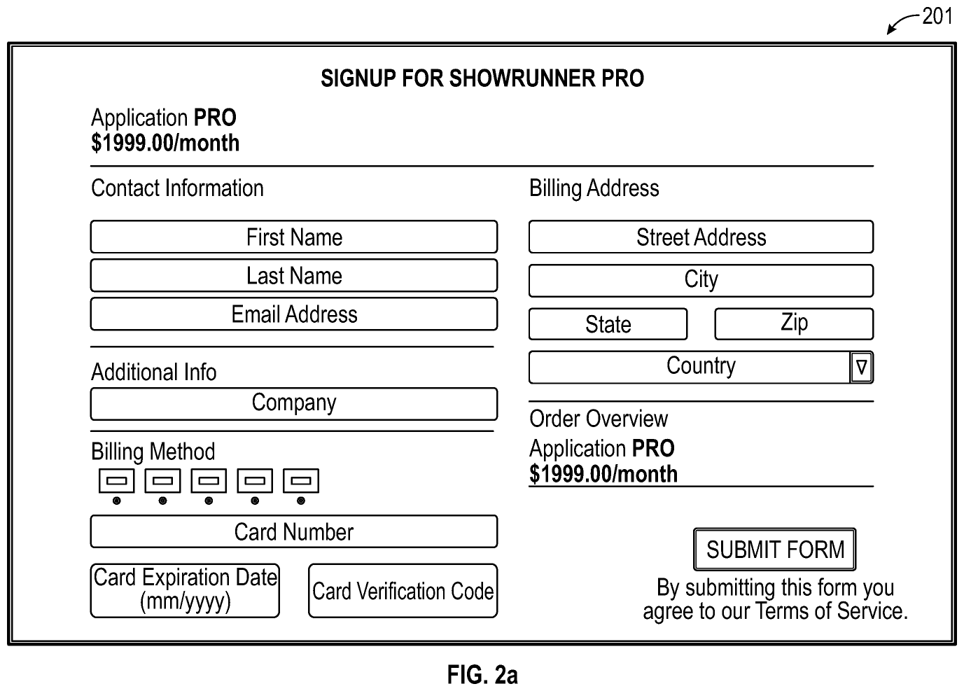

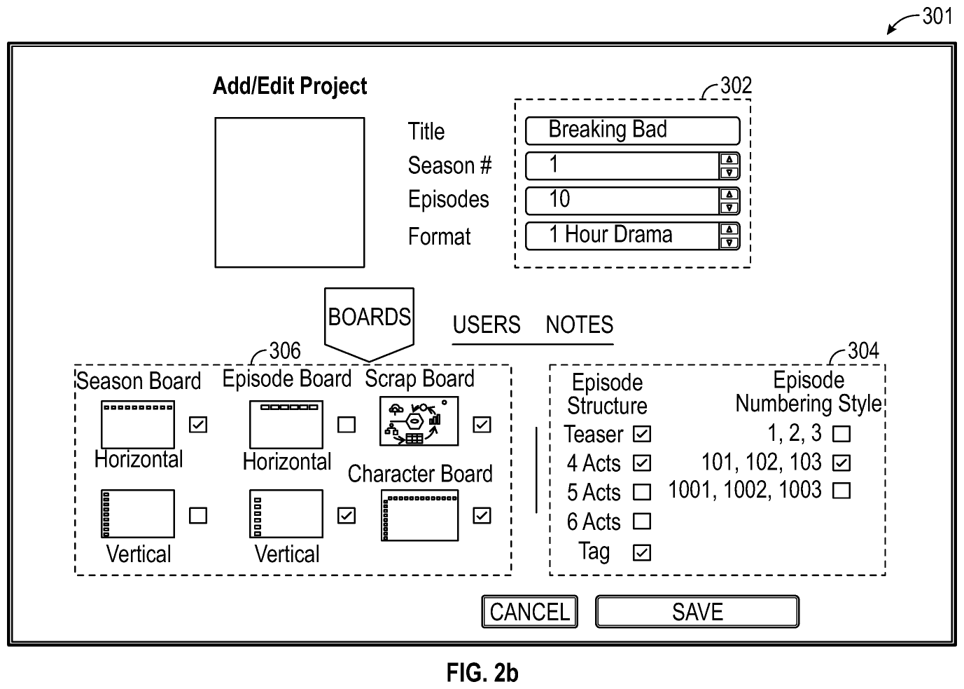

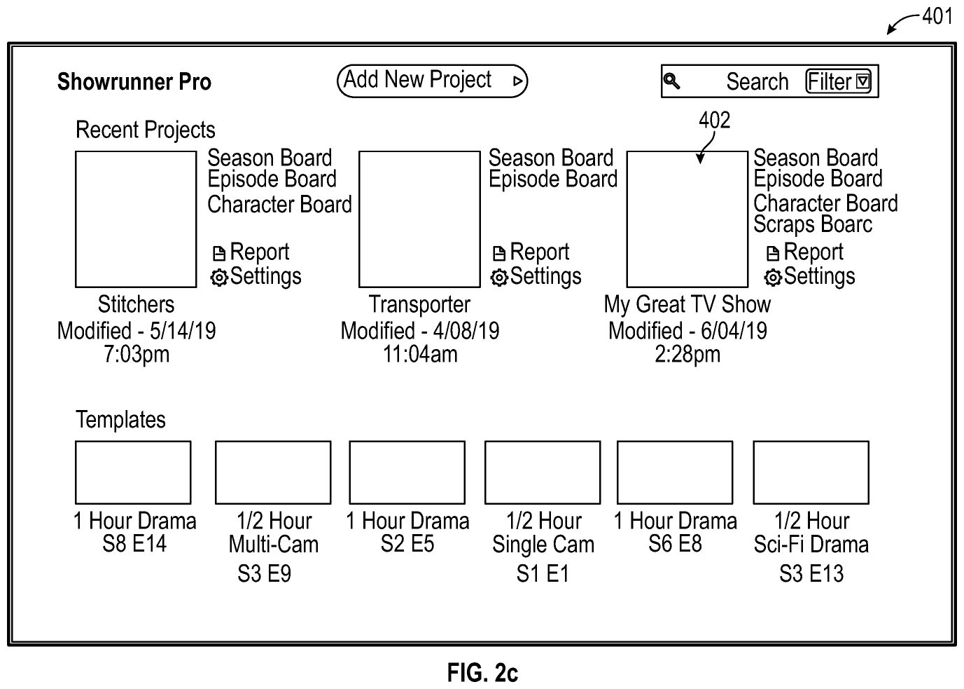

FIG. 2 shows an exemplary workflow of the present invention from the perspective of a user signing up for the software service on a display screens, creating a new project, and the display of the project. FIGS. 2a-2c are diagrams showing screens that may be presented to the user in each step of the flow. Thus, in step 200, a user may be presented on his/her connected display, online registration page 201 shown in FIG. 2a, where the user may input contact and payment information for a subscription to the system and related hardware setup services. In other embodiments, such as enterprise editions of the inventive software as a service, a company may license “seats” to the software for multiple individuals. In such case, this step may have been completed by the company, who may provide all users with a username and password to log on to the service, in which case this screen 202 or a similar screen would not be presented. In any event, once a user is registered and logs on, the user may be brought in step 300 to Add/Edit Project setup screen 301 in order to enter information about the project her or she is creating (or editing). This information may include show title, the season number of the show being created, the number of episodes to be created for that season (if a television production), and the genre, or format of the show (block 302). In other embodiments, there may be other options, for example, creating feature films and/or long form selection. In such cases it will be understood, that the setup screens and subsequent e-boards (below) may be modified accordingly.

In exemplary screen 301 in FIG. 2b, the user via block 306 then may select which and how many of the four typical writers' room boards they wish to create for the project. As seen and discussed in detail below, these four commonly used boards are a “Season Board”, an “Episode Board”, a “Character Board”, and a “Scraps Board”. As further seen in 306, the user may also be given the option to select the orientation of each board: horizontal or vertical. In block 304, the user may select which of any of multiple “episode structures” he or she wishes to use for the new project. Those user-selectable elements include a “teaser” option (a short segment usually before the opening credits), how many “acts” will follow the teaser (typically three to six), and a “tag” (a short segment at the end of the episode), as well as an episode numbering style which can be either single, triple, or quadruple digits.

Once all options are selected, in this embodiment, the user saves the settings. The process then moves to step 400, where the software will generate to the user's display, the user's “Main page” or “Home page” 401 seen in FIG. 2c, an entry that now adds the new project 402 (in this example, the show Breaking Bad). At this point, the user is allowed to tweaking the previous choices via the “Settings” icon. Also, if added to a project in the settings, a project may have a graphical icon associated with it for easy identification from the Home page.

Thus, once setup of a new project is complete, the user may be taken to the Home page (as well as each time a user logs onto the service), where, as best seen in FIG. 2c, an overview of all of the user's projects, as well as system-provided templates are located. As seen, the user may navigate to the desired board (season, episode, character, or scraps) by clicking on the function associate with the project (or by direct touch interaction with a touch-enabled display monitor). The user can then enter story ‘beats’, plot points, and character information on digital representations of index cards as discussed in detail in connection with the following figures. These digital cards can then be edited, stacked, color-coded, moved, and deleted. The user also has the ability to archive cards and restore cards to previously saved versions.

Additionally, through the Main Page of the application, users can open sample “Templates” from various existing TV shows and genres such as 1-hour dramas, half-hour romantic comedies, etc. These templates serve as examples for users as to how television shows may be structured, based on other preexisting shows. Additionally, while setting up a project, an administrator may be appointed with user management rights, enabling him or her to assign other users to each project as well as enable what kind of access each user has, e.g. administrative access, read/write access, or read only access.

Using the user-entered data, the software dynamically generates the appropriate digital screens, or boards. As shown, back in FIG. 1, each screen can be assigned by the user to a physical display monitor 2 the user has elected to use. In other embodiments, remote users can toggle or tab to the various boards on a single display or multiple device displays.

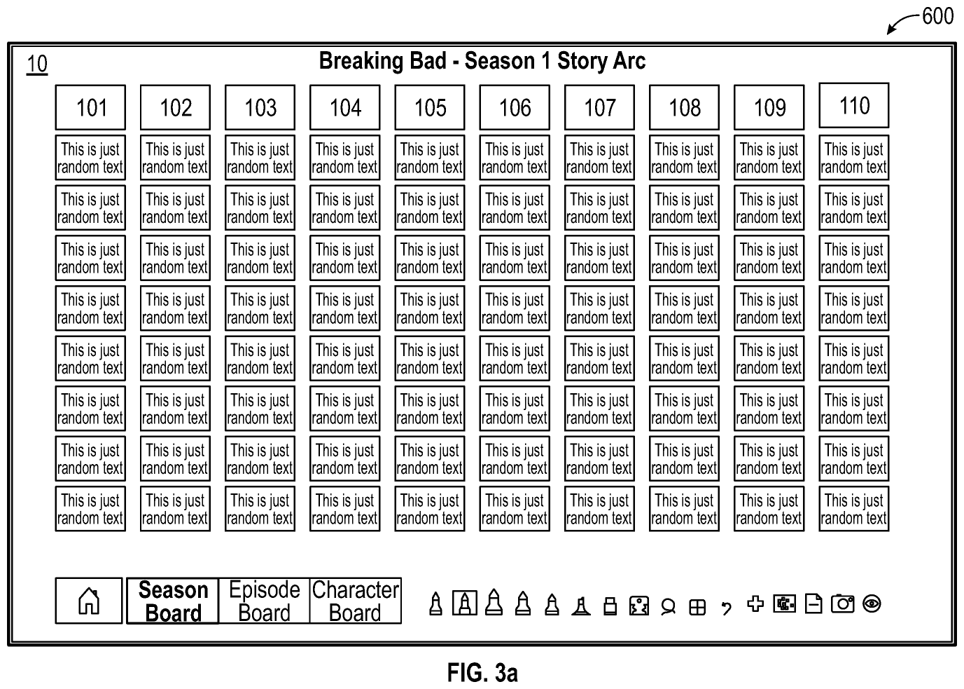

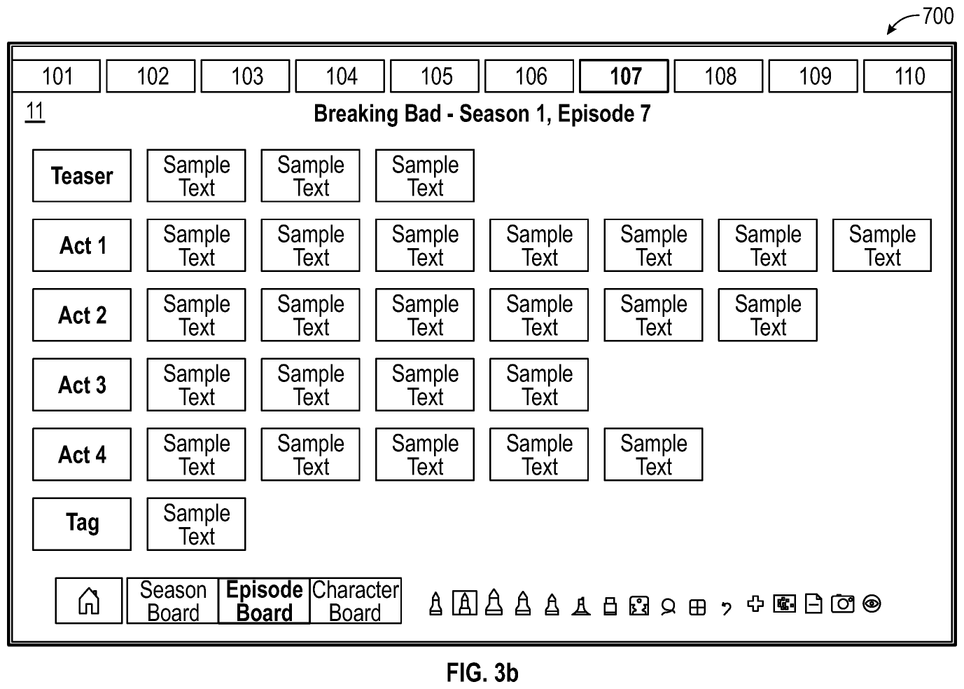

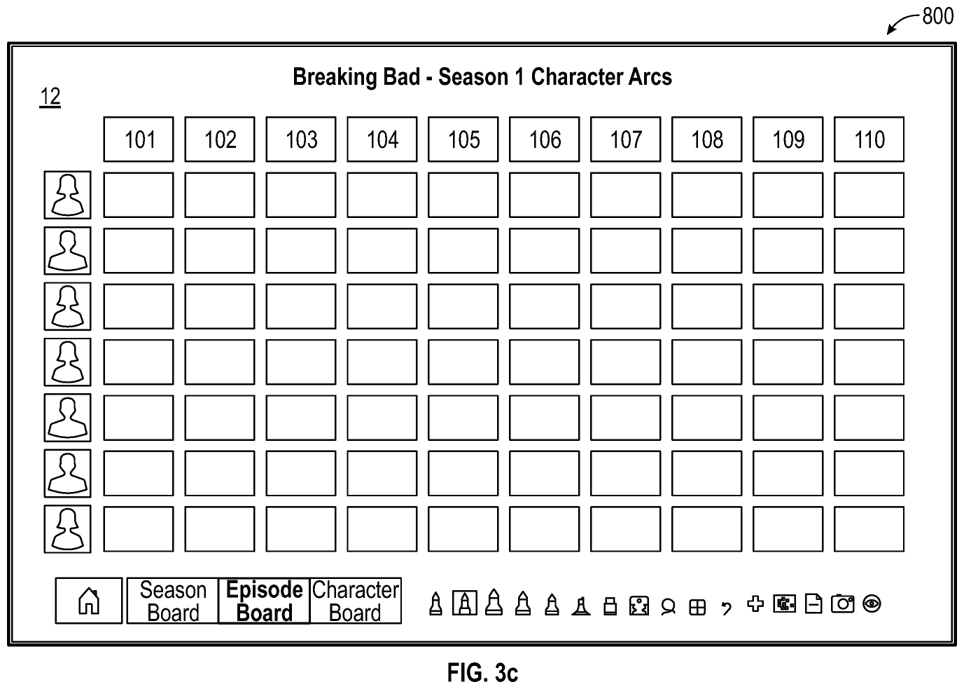

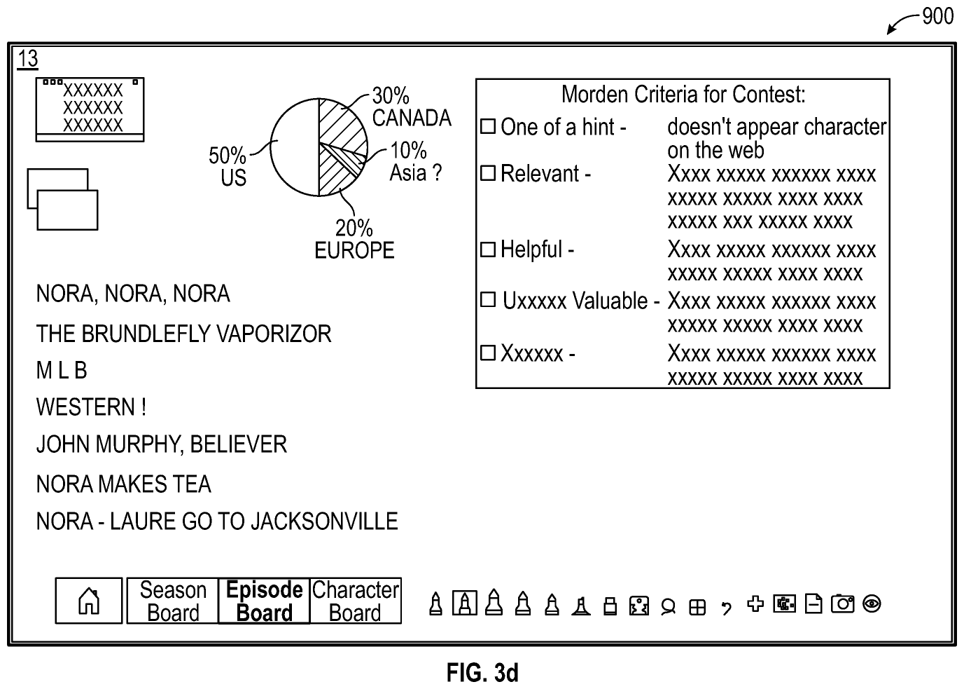

FIGS. 3a-3d are exemplary screenshots showing embodiments of the novel graphical user interface (GUI) designs of each of four e-boards/screens 10, 11, 12, and 13 shown FIG. 2, block 500 that may be generated by the software of the present invention. As discussed above, the software takes the user-generated inputs to create a navigable and interrelated set of editable and easily manipulated blank “digital index cards” that match the desired specifications for the project. For a given show season, these screens may include, but are not limited to, episode name, numbering in accordance with the numbering style selected in setup, and total number of episodes for the season. In preferred embodiments, as shown cards take the general shape of horizontally oriented rectangles that can be increased or decreased in size by the user through a “+” and “−” size function for ease of viewing and editing. These cards are then assigned by the software to their proper electronic “board” or graphical user interface e-board: Season Board 10, Episode Board 11, Character Board 12, or Scraps Board 13. Season Board 10, Episode Board 11, Character Board 12 displays these cards in a two-dimensional matrix, closely mimicking how writers' room boards and cards operate. Each novel e-board GUI and their interrelations will now be explained.

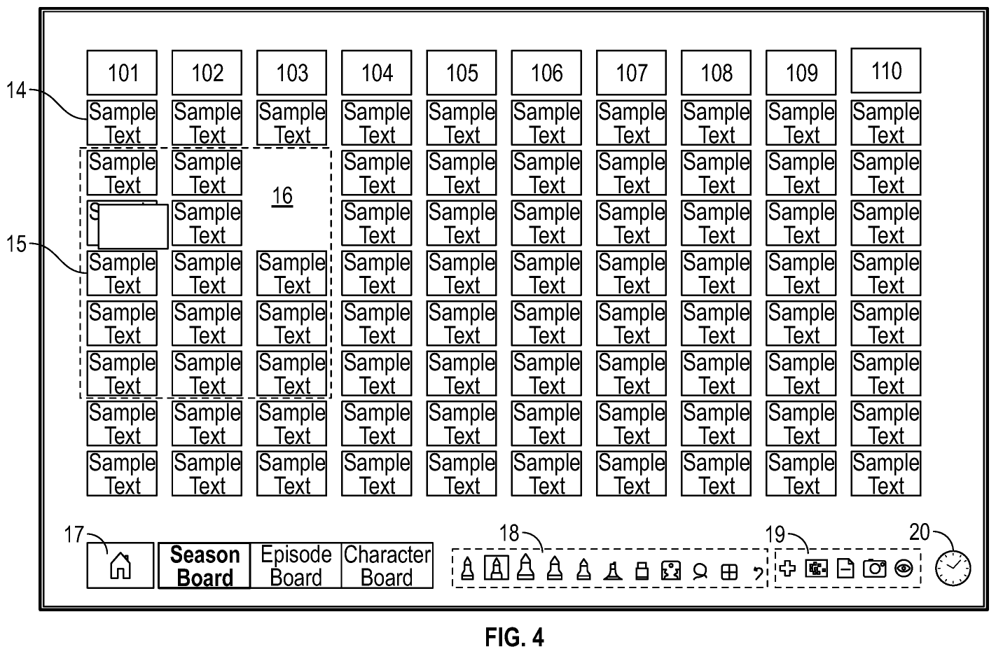

Screen 600 of FIG. 3a includes graphical user interface or GUI 10—the Season Board—a matrix that enables the user to enter and see information in each card relating to the main story points for each episode of a given season, displayed on a single, clean e-board. This enables the writers on the team to visualize the “story arc” for each season. Thus, merely as an example, GUI 10 shows the Story Arc for the 10 episodes 101-110 of Season 1 of the show Breaking Bad in columnar form. As seen here, eight (8) discrete story points for each episode are shown. It should be understood that a Season Board is not limited to any number of episodes or number of story points per episode, as the GUI allows for scrolling in both the horizontal direction for adding any number of story points for an episode, and in the vertical direction for viewing any number of episodes that may not be viewable on the display of the user. GUI 10 (and all GUIs) may also include navigation, font and function bars, here shown at the bottom of screen 600. These are the same or similar to bars 17, 18 and 19 detailed in FIG. 4 below.

Screen 700 of FIG. 3b includes GUI 11 which presents an “Episode Board” having an “Episode Board Matrix” that allows the user the focus on a specific episode among all or many episodes of a season and to enter greater detail than in the Season Board. Specifically, the Episode Board allows the user to select an episode of any given season (shown here shown across the top of GUI 11) in order to develop or review that episode. Depending on the Episode Structure selected at setup, this GUI may optionally (as shown) include a “Teaser” row (a “teaser” being a short segment usually before the opening credits), a number of “Act” rows and a “Tag” row (a “tag” being a short segment at the end of the episode). In the exemplary Season Board 11 of FIG. 3b, shown is a GUI for episode 7 (designated in the top navigation row as Episode 107) of season 1 of the show Breaking Bad, comprising a Teaser row, four (4) Acts, and one Tag.

Screen 800 of FIG. 3c includes GUI 12—a Character Board comprising a Character Board Matrix which is structurally similar to the Season Board 2-D matrix 10. This GUI allows the user to enter information in Character Development Cards (CDCs) regarding individual characters in the show across episodes of a given season, so that each character's growth and evolution can be tracked through each episode of the season. Finally, Screen 900 of FIG. 3d presents a “Scraps Board”. As seen, this board is less structured than the others in that it allows for the creation and recording of a wide variety of digital content, such as images, handwritten notes, and as well as digital index cards in order to store information, ideas, and concepts that don't have a spot at the moment of creation on the other three boards. When desired, the user can move this content to the appropriate board at will.

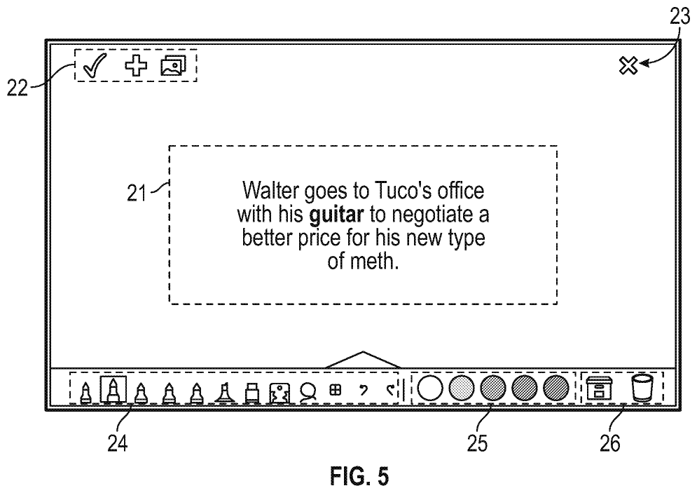

Movement among and operating on the various GUI boards is intuitive and seamless. FIG. 4 details the some of these navigation operations and features in GUI 10, the Season Board, although as seen in FIGS. 3a-3d, these features are persistent in all boards. In particular, navigation bar or menu 17 on each GUI screen, here shown on the bottom of the screen, allows the user to switch the screen on a computer display to any of the boards either through mouse/touchpad selection, with touch/stylus, if available, or other means. Cards 14 generated by the software that start out blank are, as further shown in FIG. 5, populated with text entered by the user using a keyboard or other text input tool of a computer or handheld device that is logged into the software (or stylus, if the display monitor is touchscreen).

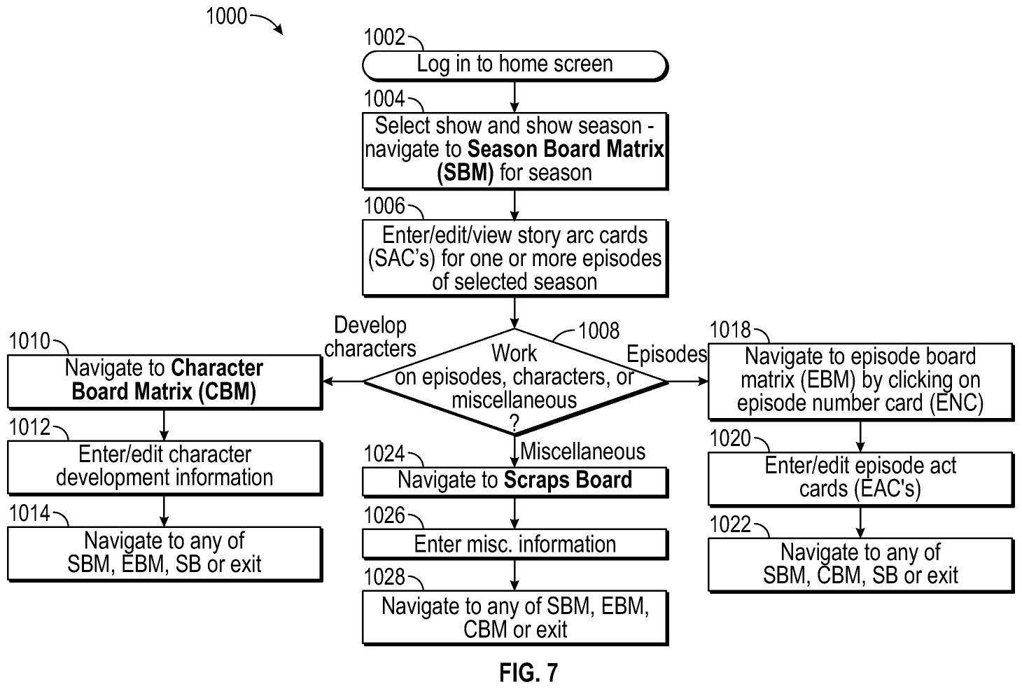

Accordingly, FIG. 7 is flow diagram showing how one or more users may operate one embodiment of the present invention after a project has already been set up. This example flow will describe how a show writer/user sitting, for example, at her computer at home with a display, keyboard and mouse may use the platform, although it is understood that any of the remote or in-office user experiences and devices described above may equally work. In this exemplary method 1000, at step 1002 the user logs onto the home screen and selects at step 1004 the show and show season she is working on. She decides to go to the Season Board Matrix 10 to review at higher level the show season she is working to get an overview. At step 1006, the user reviews the Story Arc Cards (SACs) for a specific episode she is working on. She may add new cards to the column, edit them, stack additional cards on top of others, or delete cards. Now, at step 1008, the user decides where to navigate next. If it is desired to next work on one or more characters in the show themselves, the user will navigate at step 1010 to the Character Board GUI/Matrix 12. There, at step 1012 she will enter, edit the desired information into Character Development Cards (CDCs) for the characters of interest, or even add new characters to the episode/season. When done, using the navigation panel on the screen, the user may then at step 1014, navigate to any of the other 3 boards or may exit.

Similarly, if the user at step 1008 decides to work on acts of a specific episode, she will at step 1018 navigate from the Season Board to the Episode Board Matrix 11 for the selected season by clicking on the Episode Card shown on the screen. Then, she may enter or edit Episode Act Cards at step 1020 and then navigate to other screens or exit at step 1022. Likewise, should the user navigate at step 1024 to the Scraps Board, she may enter thoughts, images and other information at the free flow screen at step 1026 and the navigate away or exit at step 1028. It is readily seen that the interface and GUI allow for great flexibility for the user. Moreover, in a team collaboration scenario (whether local or remote) different users can work on different matrices or even the same matrix (or screen) at the same time.

Back to FIG. 4, in addition to the navigation menu 17, all boards may preferably share several other common functionalities: (1) “Card Stacking and Color Coding”—cards may be stacked, color coded 15, and erased, allowing the user to add more data than possible on a single card, to associate cards with each other through stacking, and to create a visual cues as to the nature of the card through the use of color-coding. For example, red cards may be designated as “action” sequences, and blue cards may represent “character moments”, etc. (2) “Card Drag and Drop”—cards may be dragged and dropped “before”, “after”, or “between” other cards, triggering the system to auto-arrange the other cards to make room 16 for the card that was moved. For example, as seen in column 103 (representing episode 3 of the selected season), a user may insert a new card between two other cards in a column, causing the software to push down all of the cards in the column following the inserted card. (3) “Font Manipulation”—Some or all screens may have accessible pen/writing tools 18 to select text font, color, brush color, eraser function, etc. These tools allow the user to customize the text in cards using different pen/brush width, pen color, and text color. (4) “Icon-based Feature Set”—Selectable icons 19 may be included on all or some of the GUI boards to allow for a rich feature set. As seen, an icon may available for creating new cards (the “+” icon), bringing up sophisticated charts to visualize data (the “chart” icon), creating various reports based on the user data (the “reports” icon), taking visual snapshots of an entire or selected portions of the board (the “camera” icon), and triggering a screensaver for privacy (the “privacy” icon). This last feature obscures all of the content on the screens, locking all screens, which can then only be unlocked in an authorized manner either through a user entered passcode or some other identifier device; (5) “Board Back-Ups”—The contents on all boards are preferably by default automatically backed up to the software's internet-based server, allowing for secure editing and restoring of all data through a timeline function 20.

Advantageously, cards on any of the boards may be selectable (clicked) and hyperlinked to an expanded version of the card, enabling easy text entry, editing and preventing accidental editing or changes to the card on the boards. FIG. 5 shows an expanded view of one such exemplary individual card showing key navigation and modification controls, as well an example of how color-coding of cards operate and appear. In particular, text may be entered in a text box 21 of an expanded card using an appropriate text input means, such as a physical keyboard, mobile device, on-screen keyboard, or voice-enabled entry, allowing the user to dictate the contents of a card and have it automatically transcribed to editable text. As further seen with the arrow below the text box, text entry is not limited to the visible portion of the text box 21. Rather, text may auto-scroll and/or auto-scale as its entered, allowing for more or less text on each card as needed. Edits may be saved or auto-saved. New cards can be added with the “+” icon at box 22, media such as images, audio, or video can be added to each card via the image icon at box 22 to enhance and clarify through visuals and/or audio the intent of the text on each card, and edits can be cancelled and rejected by pressing the “x” icon 23. Moreover, each card may have text editing tools such as text manipulation and color selection toolbar 24, as well card background color selection at card color toolbar 25. Finally, cards may also be archived and deleted at card archive and delete toolbar 26.

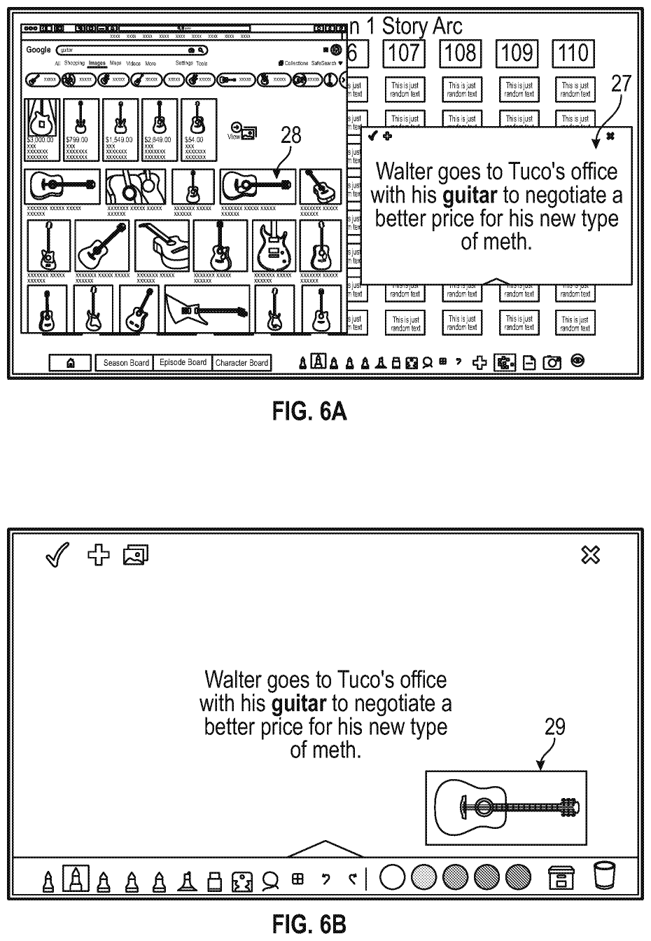

The cards themselves may be feature rich. The software of the present invention can be programmed to automatically create hyperlinks on certain words on a card by following rules of grammar (e.g., identifying people, places, and items). Alternatively, the user can create hyperlinks manually. Thus, as seen in FIG. 6a, the exemplary card contains the hyperlinked word “guitar” 27. When this word is “clicked”, a contextual search window 28 from the Internet pops up with images related to the word. As seen in FIG. 6b, one or more of these images may be dragged from the Internet search window 28 to a portion of the card 29 as reference for the user. Alternatively, these images can be saved and displayed as a URL. Additional features on cards may include (a) “badges” that indicate all remote users logged into a project; (b) identifying information as to which board and/or card the remote user is currently editing; (c) the ability to preview text on a card by pressing and holding (long press) the card to open a preview window; (d) filtering which cards are visible via card color and/or character; and (e) selective locking and hiding of episodes so that different users can be given different access to parts of a project.

Additional optional features such as text search capabilities, handwriting-to-text transcription, and keyword searches through automatic hyperlinks can all be added to further increase functionality. These searches can be filtered based on user specified criteria.

In yet a further embodiment, the system and method of the present invention may be modified for use by a television or film production's “line producer” that tracks multiple production-related events across both key milestone dates as well as from episode-to-episode. Such a system optionally provides for this additional type of “line producer board.” Thus, a “Line Producer Board may be added with features directed to more time-based tasks, allowing the user to add scheduling, deadlines, milestones, and reminders to the cards on the board.

An additional advantage of the present system and methods is that users can remotely access the cloud-based app in real-time and in collaboration with any other user logged into the same “project”.

Moreover, the editing of virtual cards may be non-destructive, and users may use a dynamic timeline GUI to revert the content back to any previous date and/or version of their work. This timeline feature may be located on every screen, and by activating it, the user can see a representation of all the changes that were made over the entire time frame. As a result, no content that's been created is lost or permanently erased, and all of the writing is accessible from any device with a browser by multiple team members and users depending on the permission granted to them by an administrator during the initial set up procedure.

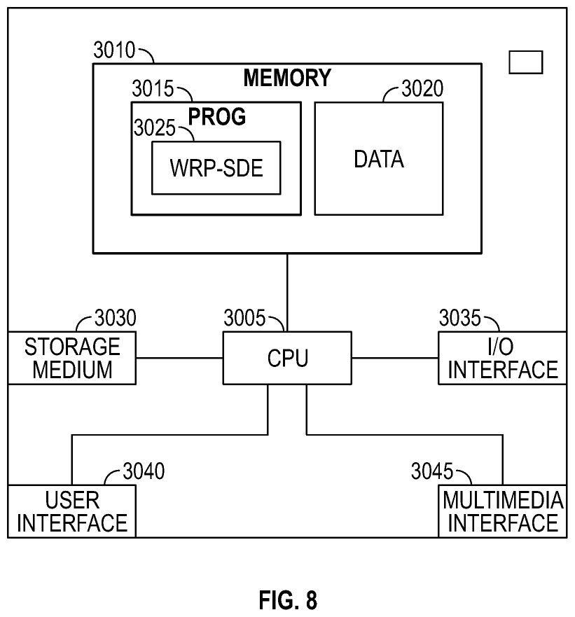

In various examples, the method steps given in the flow diagrams depicted above may be given from the perspective of the WRP-SDE (WritersRoom Pro Show Development Engine) 3025 executing as program instructions on the WRP Show Development Engine platform 3000 processor 3005, depicted in FIG. 8.

FIG. 8 is a diagram showing a structural view of an exemplary show writers' show development system configured in accordance with various embodiments of the present invention. In FIG. 8, the block diagram of the exemplary show development platform 3000 includes processor 3005 and memory 3010. The processor 3005 is in electrical communication with the memory 3010. The depicted memory 3010 includes program memory 3015 and data memory 3020. The depicted program memory 3015 includes processor executable program instructions implementing the WRP-SDE 3025. In various implementations, the depicted data memory 3020 may include data configured to encode a predictive analytic model. In some embodiments, the illustrated program memory 3015 may include processor-executable program instructions configured to implement an OS (Operating System). In various embodiments, the OS may include processor executable program instructions configured to implement various operations when executed by the processor 3005. In some embodiments, the OS may be omitted.

In some embodiments, the illustrated program memory 3015 may include processor-executable program instructions configured to implement various Application Software. In various embodiments, the Application Software may include processor executable program instructions configured to implement various operations when executed by the processor 3005. In some embodiments, the Application Software may be omitted. In the depicted embodiment, the processor 3005 is communicatively and operably coupled with the storage medium 3030. In the depicted embodiment, the processor 3005 is communicatively and operably coupled with the 3a-3f (Input/Output) interface 3035. In the depicted embodiment, the 3a-3f interface 3035 includes a network interface. In various implementations, the network interface may be a wireless network interface. In some designs, the network interface may be a Wi-Fi interface. In some embodiments, the network interface may be a Bluetooth interface. In an illustrative example, the WRP Show Development platform 3000 may include more than one network interface. In some designs, the network interface may be a wireline interface. In some designs, the network interface may be omitted. In the depicted embodiment, the processor 3005 is communicatively and operably coupled with a user interface 3040. In various implementations, the user interface 3040 maybe adapted to receive input from a user or send output to a user. In some embodiments, the user interface 3040 may be adapted to an input-only or output only user interface mode. In preferred implementations, the user interface 3040 may include an imaging display. In some embodiments, the user interface 3040 may include an audio interface. In some designs, the audio interface may include an audio input. In various designs, the audio interface may include an audio output. In some implementations, the user interface 3040 may be touch-sensitive. In some designs, the WRP Show Development platform 3000 may include a GPS module operably coupled with the processor 3005.

In an illustrative example, some or all parts of the WRP Show Development platform 3000 may be included within a client device, such that the functionalities could operate in a distributed manner as a Software as a Service (SaaS). In some embodiments, the user interface 3040 may include an input sensor array. In various implementations, the input sensor array may include one or more imaging sensor. In various designs, the input sensor array may include one or more audio transducer. In some implementations, the input sensor array may include a radio-frequency detector.

In the depicted embodiment, the processor 3005 is communicatively and operably coupled with the multimedia interface 3045. In the illustrated embodiment, the multimedia interface 3045 includes interfaces adapted to input and output of audio, video, and image data. In some embodiments, the multimedia interface 3045 may include one or more still image camera or video camera. In various designs, the multimedia interface 3045 may include one or more microphone. In some implementations, the multimedia interface 3045 may include a wireless communication means configured to operably and communicatively couple the multimedia interface 3045 with a multimedia data source or sink external to the WRP Show Development platform 3000. In various designs, the multimedia interface 3045 may include interfaces adapted to send, receive, or process encoded audio or video. In various embodiments, the multimedia interface 3045 may include one or more video, image, or audio encoder. In various designs, the multimedia interface 3045 may include one or more video, image, or audio decoder. In various implementations, the multimedia interface 3045 may include interfaces adapted to send, receive, or process one or more multimedia stream. In various implementations, the multimedia interface 3045 may include a GPU. In some embodiments, the multimedia interface 3045 may be omitted.

Useful examples of the illustrated WRP Show Development platform 3000 include, but are not limited to, personal computers, servers, tablet PCs, smartphones, or other computing devices. In some embodiments, multiple WRP Show Development platform 3000 devices may be operably linked to form a computer network in a manner as to distribute and share one or more resources, such as clustered computing devices and server banks/farms. Various examples of such general-purpose multi-unit computer networks suitable for embodiments of the disclosure, their typical configuration and many standardized communication links are well known to one skilled in the art. In some embodiments, an exemplary WRP Show Development platform 3000 design may be realized in a distributed implementation.

In an illustrative example, some WRP Show Development platform 3000 designs may be partitioned between a client device, such as, for example, a phone, and, a more powerful server system, such as depicted in FIG. 1. In various designs, a WRP Show Development platform 3000 partition hosted on a PC or mobile device may choose to delegate some parts of computation, such as, for example, machine learning or deep learning, to a host compute server. In some embodiments, a client device partition may delegate computation-intensive tasks to a host compute server to take advantage of a more powerful processor, or to offload excess work.

In an illustrative example, some mobile devices may be configured with a mobile chip including an engine adapted to implement specialized processing, such as, for example, neural networks, machine learning, artificial intelligence, image recognition, audio processing, or digital signal processing. In some embodiments, such an engine adapted to specialized processing may have sufficient processing power to implement some WRP Show Development platform 3000 features. However, in some embodiments, an exemplary WRP Show Development platform 3000 may be configured to operate on device with less processing power, such as, for example, various gaming consoles, which may not have sufficient processor power, or a suitable CPU architecture, to adequately support a particular WRP Show Development platform 3000 design. Various embodiment WRP Show Development platform 3000 designs configured to operate on a such a device with reduced processor power may work in conjunction with a more powerful WRP Show Development platform 3000 server system.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc. The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few. The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications/alerts and user interfaces described herein may be provided via a Web page, a dedicated or non-dedicated phone application, computer application, a short messaging service message (e.g., SMS, MMS, etc.), instant messaging, email, push notification, audibly, a pop-up interface, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. While embodiments of the invention have been illustrated and described, it is not intended that these embodiments illustrate and describe all possible forms of the invention. Various changes, modifications, and alterations in the teachings of the present invention may be contemplated by those skilled in the art without departing from the intended spirit and scope thereof. It is intended that the present invention encompass such changes and modifications.

What is claimed is:

1. A computer-implemented method for developing content for a show by one or more users, the method comprising:
a. electronically entering editable story arc content on one or more Story Arc Cards (SACs) for display on a first screen comprising a Season Board matrix that linearly presents the one or more SACs for each one or more selected episodes of a season of the show, with the SACs for each episode displayed with an associated Episode Number Card (ENC) identifying the episode number for the SACs of that episode; and
b. electronically entering editable episode act content on one or more Episode Act Cards (EACs) for display on a second screen comprising an Episode Board matrix that linearly displays the entered EACs for acts of the selected episode of a selected season.

2. The method of claim 1, wherein an ENC displayed on the Season Board matrix includes a link to its corresponding Episode Board matrix, such that activating said link causes the corresponding Episode Board matrix to be displayed.

3. The method of claim 1, further including entering editable character content on Character Development Cards (CDCs) for one or more characters in the show across episodes of a given season, the CDCs for display on a third screen comprising a Character Board matrix that linearly displays the CDCs of each character across episodes of the selected season of the show.

4. The method of claim 1, wherein the SACs and associated ENCs are selectably displayed on the Season Board matrix in a linearly vertical or horizontal orientation.

5. The method of claim 1, wherein the EACs are selectably displayed on the Episode Board matrix in a linearly vertical or horizontal orientation.

6. The method of claim 1, wherein multiple users may enter and edit content on SACs and EACs remotely from each other in a Software as a Service (SaaS) environment.

7. The method of claim 6, wherein multiple users may enter and edit SACs and EACs simultaneously.

8. A graphical user interface for one or more users, using one or more input devices and displays, to enter, view and navigate content for a show, the graphical user interface comprising:
a. a Season Board matrix for displaying on a first screen user-selectable and editable Story Arc Cards (SACs) for one or more selected episodes of a season of the show, the matrix including an Episode Number Card (ENC) associated with the SACs for each episode, the ENCs identifying the episode number of the selected season; and
b. an Episode Board matrix for displaying on a second screen user-selectable and editable Episode Act Cards (EACs) for each act of a selected episode.

9. The GUI of claim 8, wherein each Episode Number Card displayed on the Season Board matrix includes a link to its corresponding Episode Board matrix, such that activating said link causes the corresponding Episode Board matrix to be displayed.

10. The GUI of claim 8, further including a Character Board matrix for display on a third screen user-selectable and editable Character Development Cards (CDCs) for one or more characters in the show across episodes of a given season.

11. The GUI of claim 8, further including a Scrap Board for display on a fourth screen user-selectable and editable content

12. An apparatus comprising
a. a show development module configured to provide access to one or more users to input, revise and review content for a show on screens of one or more electronic displays, comprising:
i. a processor; and,
ii. a memory that is not a transitory propagating signal, the memory operably coupled with the processor and encoding computer readable instructions, including processor executable program instructions, the computer readable instructions accessible to the processor, wherein the processor executable program instructions, when executed by the processor, cause the processor to perform operations comprising
1. display a user editable Season Board matrix on a first screen, comprising one or more user-entered Story Arc Cards (SACs) for one or more selected episodes of a selected season of the show; and, an Episode Number Card (ENC) associated with each one or more SACs of an episode; and,
2. display a user editable Episode Board matrix on a second screen, comprising Episode Act Cards (EACs) for each act of a selected episode; and
3. navigate from the user editable Season Board matrix to the user editable Episode Board matrix of the selected episode by selecting at least a portion of the Episode Number Card corresponding to the selected episode.

13. The apparatus of claim 12, wherein the show development module is accessible via a network to remote input devices of credentialed users for simultaneous viewing, inputting and editing by the users of the Season Board and Episode Board matrices.
